(19) United States
(12) Patent Application Publication
(10) Pub. No.: US 2005/0039377 A1
(43) Pub. Date: Feb. 24, 2005

(54) Fishing post cap and method of use

(76) Inventor: John E. Clary, Ames, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 10/951,977

(22) Filed: Sep. 28, 2004

Related U.S. Application Data
(63) Continuation-in-part of application No. 10/171,105, filed on Jun. 13, 2002.

(51) Int. Cl. A01K 97/06; A01K 97/10

(52) U.S. Cl. 43/54.1; 43/21.2

(57) ABSTRACT

A fishing post cap that is configurable to dock posts of different cross-sectional areas. The post cap may have a carrying handle. Attached to the cap are a plurality of post cap accessories, such as cup holders, mini-tackle box, a fishing pole holder and gear hooks. The method of using the fishing post cap includes positioning the fishing post cap upon one post and then reconfiguring for another post if necessary. The method also includes the step positioning the fishing pole over water.

### CROSS-REFERENCE TO RELATED APPLICATIONS

This application is a continuation-in-part and claims benefit from U.S. application Ser. No. 10/171,105 filed Jun. 13, 2002 of which is incorporated herein by reference.

### FIELD OF THE INVENTION

This invention relates to a removable post cap for attachment atop one of the dock support posts of docks or piers, commonly used to extend access from the shore out into a lake, ocean harbor, etc.

### BACKGROUND OF THE INVENTION

This invention relates to a device, based upon a removable post cap particularly adapted for attachment to exterior end posts of docks, commonly associated with fresh water lakes. It is understood, however, that it could also be used for piers that extend into the ocean.

Docks or piers allowing access beyond just the shoreline of fresh water lakes or to the ocean are common. The invention will be described hereafter particularly with respect to fresh water lake docks, but it is understood that it could be used with piers as well.

Commonly along fresh water lakes, the shoreline property owners use docks. The dock provides accessibility to a boat hoist, the lakeshore owner's boat, and provides a seating area to enjoy sitting, surrounded by water for fishing or relaxation.

One of the reasons the end of such docks are used for fishing is because the area under the docks and the shadows caused by the dock usually provide an area around which fish congregate. When one is engaged in such fishing activity, one's tackle box, lures and leaders are all at risk as they sit on the end of the dock. It is not uncommon to spill those over into the water, losing them.

Moreover, the top end of dock posts are often susceptible to environmental damage caused by extreme heat, sun, rain, moisture, humidity, etc. As a result, dock posts, particularly if they are of wood, commonly rot. If they are metal tubes, it is not uncommon to lose things, falling down into the interior shaft of the dock post.

It therefore can be seen that a need exists for some sort of a system to be placed on top of dock posts which allow safekeeping of fishing gear, lures, etc. and which provides an environmentally safe protective cover on top of the dock post. This invention has as its primary objective the fulfillment of this need.

### SUMMARY OF THE INVENTION

With respect to the preferred embodiment, the invention provides a post cap which can be positioned on top of an end dock post. The post cap is easily removable from the post to allow easy, convenient portability from one post to another. The post cap has attached a plurality of post cap accessories. Acceptable and usable accessories include, but are not limited to, cup/can holders, a mini-tackle box, fishing pole holders and gear hooks.

The post cap is configurable to dock posts of different cross-sectional areas. The method of using the fishing post cap includes positioning the fishing post cap upon one post and then reconfiguring for another post if necessary. The method also includes the step positioning the fishing pole over water.

### BRIEF DESCRIPTION OF THE DRAWINGS

FIG. 1 is a fishing post cap in perspective view mounted on a dock post.

FIG. 2 is a fishing post cap in perspective view with the tackle box open and a bottom insert section hanging by a tether.

FIG. 3 is a side view of the fishing post cap with a loop for attaching a live well, fish basket and/or fish stringer.

FIG. 4 is a side view of the fishing post cap with a fishing pole holder.

FIG. 5 is a top view of the fishing post cap.

FIG. 6 is a bottom view of the fishing post cap.

### DETAILED DESCRIPTION OF THE PREFERRED EMBODIMENT

This invention relates to an integral dock post cap referred to generally as 10 for fitting over the top end of dock post 12.

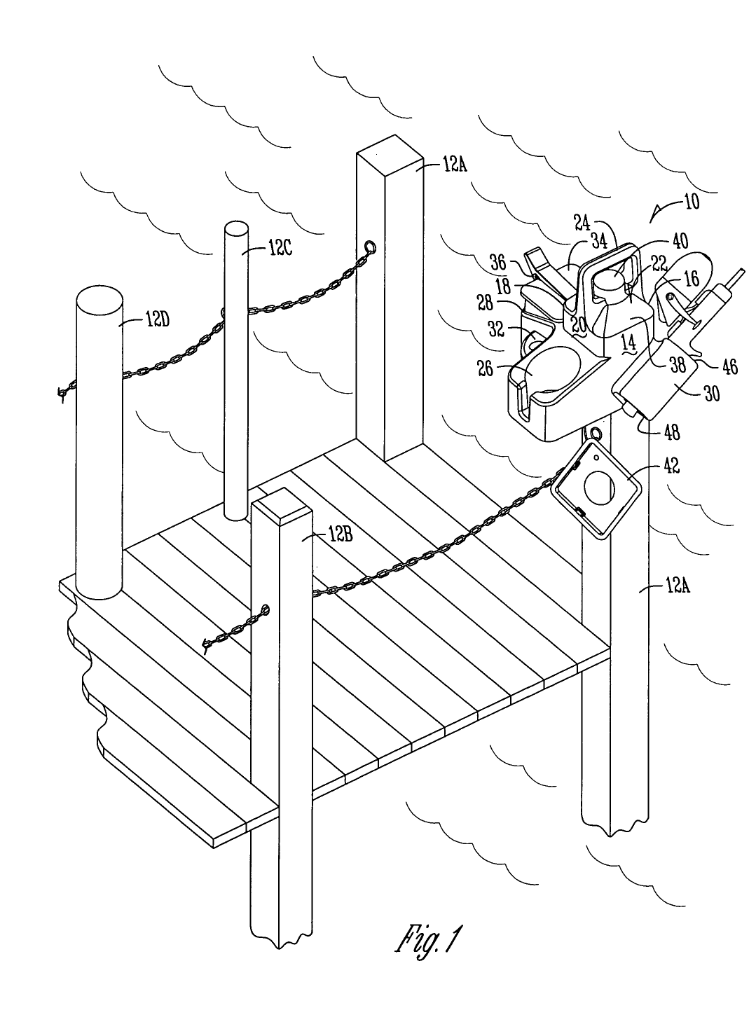

Referring now to the post cap 10 as seen in FIG. 1, it comprises four sides 14, 16, 18 and 20 and a top 22, all joined to form a cap which can fit over dock posts 12A-D. Attached to the post cap top 22 is handle 24. It can therefore be seen that cap 10 can be inserted over the top of the posts 12A-D and may provide an environmental-proof top. Moreover, the cap 10 is not attached at all and can be easily removed simply by lifting on handle 24, and sliding the cap 10 and all of the attached accessories off the post thus making it an easy carrier for the contents of the cap accessories.

Attached to the various sides 14, 16, 18 and 20 of post cap 10 are a variety of post cap accessories. The accessories can vary as much as the imagination of the fisherman/lakeshore owner desires. They can include, however, a cup/can holder 26, a mini-tackle box 28, a fishing pole holder 30, and gear loops 32. The gear loops 32 may be used to hold a towel or to attach a live well, fish basket, and/or fish stringer. Mini-tackle box 28 has a lid 34 that is hingedly attached at 36 to tackle box 28. The mini-tackle box 28 has a grooved rim 35 upon which spinner bait, hooks, and/or other fishing lure may be attached. It goes without saying that other accessories could be provided in lieu or in addition to those mentioned. For example, a holder for a minnow bucket could be attached. A mini ice chest could be attached, a mini first aid kit holder could be attached, a mini radio holder could be attached, etc.

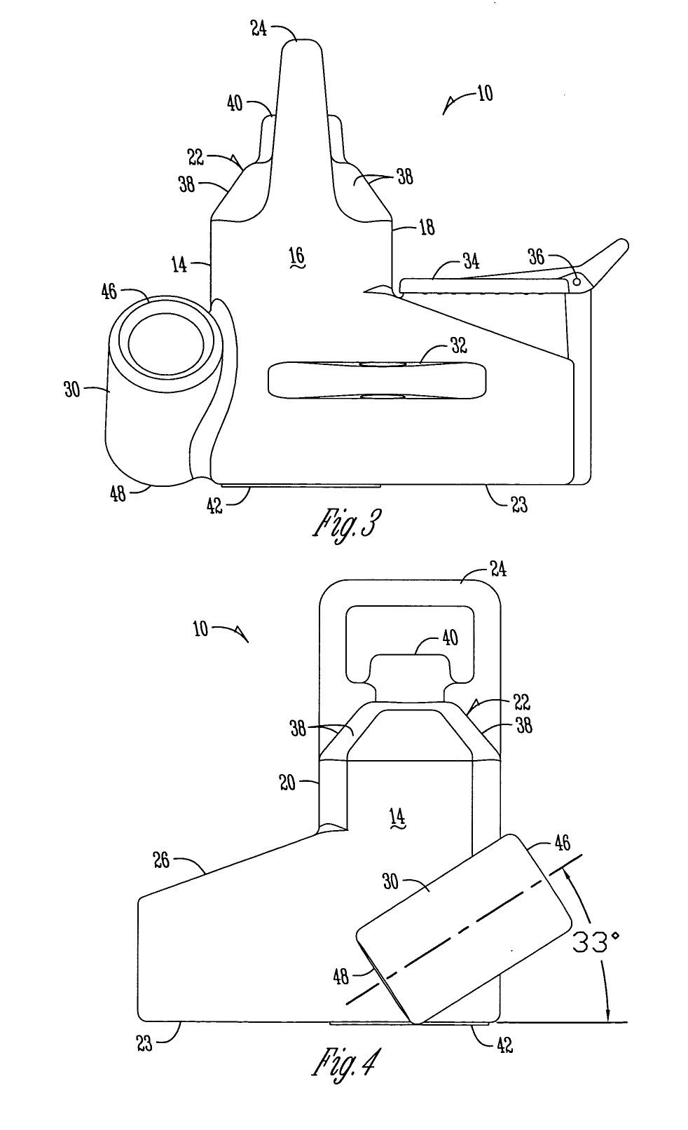

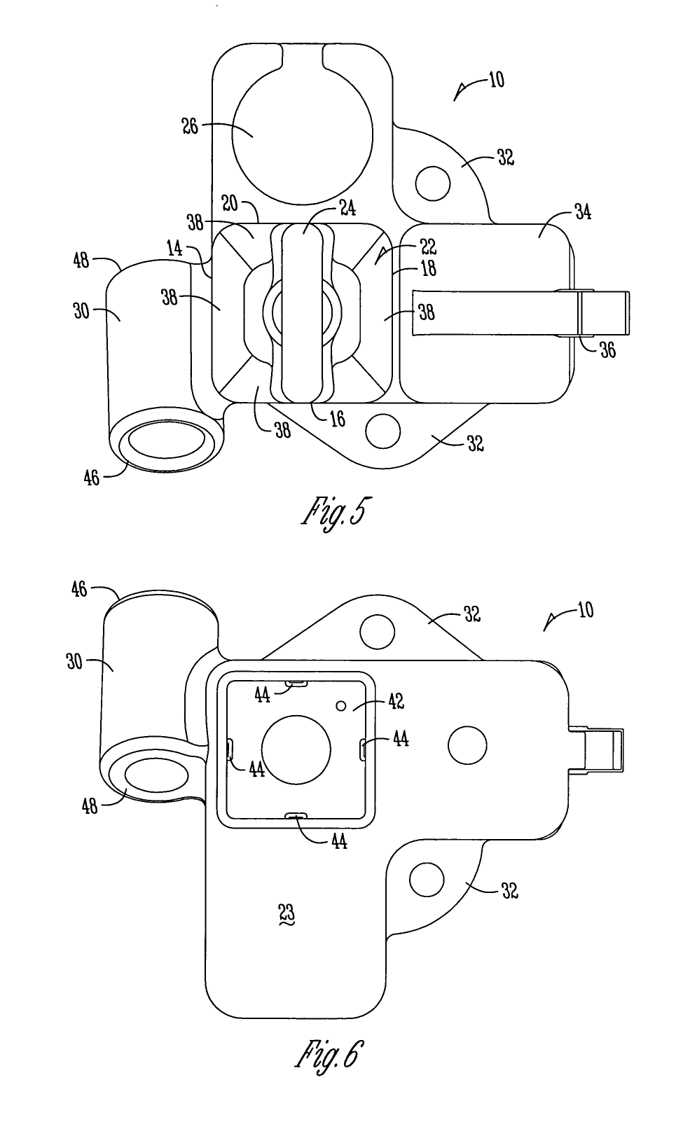

As seen in FIGS. 1, 4, 5 and 6, the fishing pole holder 30 is positioned at an angle that prevents the fishing pole from being pulled out when a fish is caught. This angle is approximately 33 degrees from the bottom of the fishing cap post 10. The fishing pole holder 30 has a front end 46 that is rounded such that the fishing pole may be easily inserted into the holder 30. The fishing pole holder also has a rear end 48 that is flat and has a pronounced sharp edge that that engages the fishing pole to prevent unintended release of the fishing pole from the holder 30.

The post cap 10 is moveable between a variety of dock posts including common rectangular and cylindrical posts. Docks are commonly constructed using a 4″×4″ square wooden posts, a 3″ diameter cylindrical wooden posts, 1½″ to 2″ diameter metal rods, a combination of wooden post and metal rod, and/or other wooden post and metal rod. As illustrated in FIG. 1, the post cap 10 is in place upon dock post 12A that has an approximately flush top end. The post cap can be moved to dock post 12B that has a beveled upper end or the post cap 10 can be reconfigured using bottom insert 42 to be placed upon rod 12C.

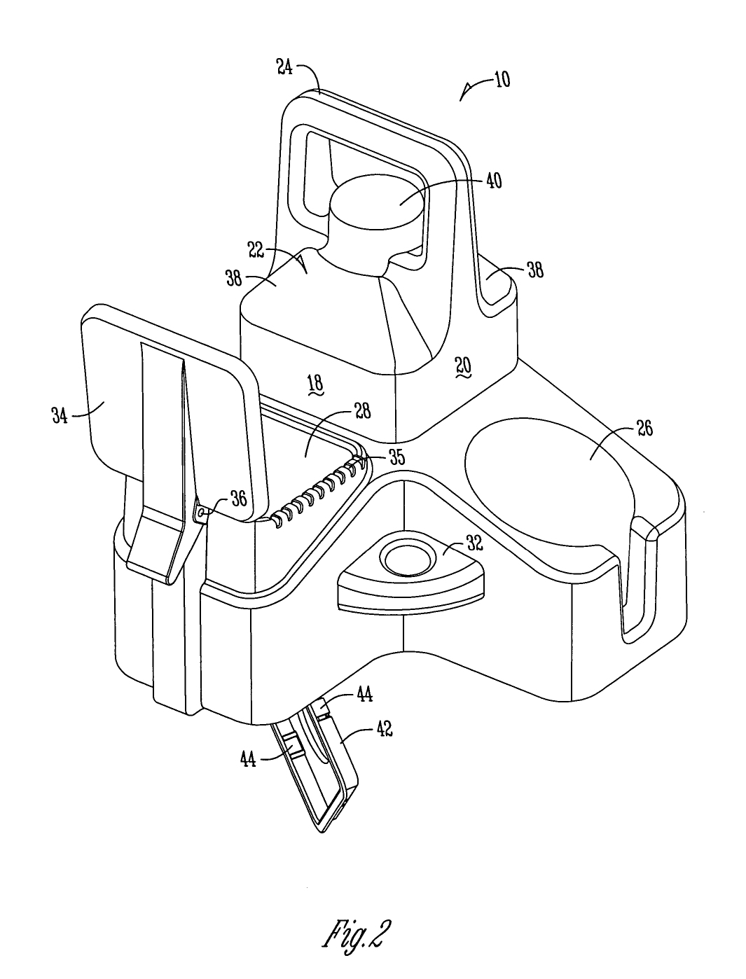

As seen in FIGS. 2-6, the post cap 10 has a tapered portion 38 that accommodates a variety of rectangular posts and cylindrical posts. As illustrated, the fishing post cap 10 is designed to fit upon a 4″×4″ square post. The fishing post cap 10 also accepts dock posts 12B that have a top bevel and permits the posts 12B inclined surface to rest against the inner side of the tapered portion 38.

The fishing post cap accepts a variety of different sized dock posts. As illustrated, those that are sized less than a 4″×4″ rectangular post will have a top end rest upon a portion of the inner side of the tapered portion 38. The fishing post cap 10 may tilt slightly to abut the dock post 12.

The post cap 10 also has a bottom insert section 42 that, as illustrated, accepts cylindrical posts. A removable bottom insert section 42 can be seen in FIGS. 1, 2 and 6 and has clips 44 that grip an opening in the cap bottom 23. The bottom section 42 is removable so that it may accommodate different types of dock posts. The bottom section 42 has a circular opening 44 that receives a cylindrical post; which is typically 2″ or 1.5″ in diameter. The post cap 10 also has a cylindrical center section 40 for receiving the cylindrical post 12C at the top 22 of the post cap 10. The post cap 10 can also receive cylindrical post 12D that is larger than the circular opening 44 by removing the insert 42. The post cap can be made from metals such as steel and/or aluminum, or it can be plastic. If plastic, injection molded units of unitary configuration or rotomold configurations work well.

As seen in FIG. 1, the fishing post cap 10 is positioned such that a fishing pole in fishing pole holder 30 extends out over the water. Additionally, the fishing post cap 10 is positioned such that the a gear loop 32 on side 16 may have a live well, fish basket and/or fish stringer (not shown) attached to the gear loop and extend directly into the water. A live well is typically a cage for storing the fish alive in the water and also has a line attached to it for connecting the cage to a boat or dock.

From above it can be seen that the invention accomplishes all of its stated objectives.

1. A post cap configurable to dock posts of different cross-sectional areas, the post cap comprising:
a top adapted to abut an upper portion of the dock posts;
at least one side extending downward from the top;
a bottom opposite the top and attached to the at least one side, the bottom having an orifice for receiving a dock post with a first cross-sectional area;
an insert member that may be placed into the orifice in the bottom, the insert member having an opening for receiving a dock post with a second cross-sectional area;
a plurality of post cap accessories mounted to the post cap.

2. The post cap of claim 1 wherein the plurality of post cap accessories are selected from the group consisting of cup/can holders, mini-tackle box, fishing pole holder, gear loops, a mini minnow bucket, a mini radio, a mini ice chest, and a mini first aid kit.

3. The post cap of claim 1 wherein the plurality of accessories includes a cup holder, a mini-tackle box, and a fishing pole holder.

4. The post cap of claim 1 wherein the top has a tapering portion.

5. The post cap of claim 1 wherein the top has an indentation for receiving the dock post with the second cross-sectional area.

6. The post cap of claim 1 wherein the first cross-sectional area is approximately square.

7. The post cap of claim 1 wherein the second cross-sectional area is approximately circular.

8. A post cap configurable to dock posts of different cross-sectional areas, the post cap comprising:
a closed top having an outer perimeter, the closed top adapted to abut an upper portion of the dock posts;
at least one side extending downward from the outer perimeter of the top;
a bottom opposite the top and attached to the at least one side, the bottom having an orifice for receiving a dock post with a first cross-sectional area;
the top having a tapering portion extending upward from the outer perimeter;
the tapering portion receiving a dock post with a second cross-sectional area;
a plurality of post cap accessories mounted to the post cap.

9. The post cap of claim 8 wherein the plurality of post cap accessories are selected from the group consisting of cup/can holders, mini-tackle box, fishing pole holder, gear loops, a mini minnow bucket, a mini radio, a mini ice chest, and a mini first aid kit.

10. The post cap of claim 8 wherein the plurality of accessories includes a cup holder, a mini-tackle box, and a fishing pole holder.

11. The post cap of claim 8 further comprising an insert member that may be placed into the orifice in the bottom, the insert member having an opening.

12. A post cap configurable for different dock posts, the post cap comprising:
a closed top having an outer perimeter, the closed top adapted to abut an upper portion of the dock posts;
at least one side extending downward from the top;
a bottom opposite the top and attached to the at least one side, the bottom having an orifice for receiving a dock post that has an approximately square cross-section;
the top having a tapering portion extending upward from the outer perimeter for abutting a dock post that has a tapered upper portion;
the tapering portion receiving a dock post with a second cross-sectional area;
an insert member that may be placed into the orifice in the bottom, the insert member having an opening for receiving a dock post that has an approximately circular cross-section;
a plurality of post cap accessories mounted to the post cap.

13. The post cap of claim 12 wherein the plurality of post cap accessories are selected from the group consisting of cup/can holders, mini-tackle box, fishing pole holder, gear loops, a mini minnow bucket, a mini radio, a mini ice chest, and a mini first aid kit.

14. The post cap of claim 12 wherein the plurality of accessories includes a cup holder, a mini-tackle box, and a fishing pole holder.

15. A fishing post cap moveable between posts, the fishing post cap comprising:
a post cap configurable between posts selected from the group consisting of posts having an approximately square cross-section, posts having an approximately circular cross-section, and posts having a tapered upper end;
a carrying handle on the post cap;
a tackle box attached to the post cap; and
a fishing pole holder.

16. The fishing post cap of claim 15 further comprising a gear loop for a live well and a fishing pole holder.

17. The fishing post cap of claim 16 wherein the gear loop for the live well and the fishing pole holder are approximately 90 degree offset from one another.

18. The fishing post cap of claim 17 wherein the fishing pole holder positions a fishing pole parallel with the gear loop for the live well.

19. The fishing post cap of claim 15 wherein the tackle box has a grooved ridge that is adapted to hold fishing tackle.

20. The fishing post cap of claim 15 wherein the fishing pole holder is positioned upon the fishing post cap at approximately a 33 degree angle.

21. The fishing post cap of claim 15 wherein the fishing pole holder has a rounded front end to facilitate placement of a fishing pole into the holder and a flat end with a sharp edge to prevent a fishing pole from coming out of the holder.

22. A method of using a fishing post cap configurable for movement between posts including posts having an approximately square cross-section, posts having an approximately circular cross-section, and posts having a tapered upper end, the method comprising:
providing a post cap with a bottom orifice, a tackle box and a fishing pole holder;
positioning the post cap bottom orifice onto a first post with a first cross-sectional area such that the fishing pole holder may direct a fishing pole over water.

23. The method of claim 22 further comprising the steps removing the post cap from the first post, placing an insert member with an opening into the orifice, and positioning the opening onto a second post having a second cross-sectional area smaller than the first cross-sectional area.

24. The method of claim 22 further comprising the steps removing the post cap from the first post and positioning the opening onto a third post having a third cross-sectional area smaller than the first cross-sectional area.

25. The method of claim 22 further comprising the step removing the post cap from the first post and positioning the bottom orifice onto a fourth post with a tapered upper end.
